(19) United States
(12) Patent Application Publication
(10) Pub. No.: US 2025/0070557 A1
(43) Pub. Date: Feb. 27, 2025

(54) SPLIT-PHASE OUTPUT POWER ADJUSTMENT SYSTEM, ADJUSTMENT METHOD, AND STORAGE MEDIUM IN LOW VOLTAGE TRANSFORMER AREA

(71) Applicant: ELECTRIC POWER RESEARCH INSTITUTE OF YUNNAN POWER GRID CO. , LTD, Kunming (CN)

(72) Inventors: Jindong YANG, Kunming (CN); Hongwen LIU, Kunming (CN); Fei RONG, Kunming (CN); Xufeng LI, Kunming (CN); Junpeng DANG, Kunming (CN); Jisheng HUANG, Kunming (CN); Penghui YANG, Kunming (CN)

(21) Appl. No.: 18/558,348

(22) PCT Filed: Feb. 14, 2023
(86) PCT No.: PCT/CN2023/075843

§ 371 Date: Oct. 31, 2023

(30) Foreign Application Priority Data
Jun. 27, 2022 (CN) 202210736660.0

(51) Int. Cl. H02J 3/26; H02J 3/38; H02J 3/46

(52) U.S. Cl. CPC H02J 3/26; H02J 3/381; H02J 3/466; H02J 2300/24

(57) ABSTRACT

Embodiments of this invention discloses a split-phase output power adjustment system, adjustment method, and storage medium in a low voltage transformer area. The system includes adjustment power supplies, split-phase power adjustment modules, sub-controllers, a main controller. The adjustment power supplies connected to the split-phase power adjustment modules, and total power P of the adjustment power supplies complying with a relationship as follows: P=Pₜ=P_{G1}+P_{G2}+ . . . . P_{Gn}; wherein Pₜ is power required to comply with three-phase current unbalance adjustment of a distribution transformer, P_{G1}, P_{G2}, . . . P_{Gn} is power generated by each of the adjustment power supplies to compensate three-phase current unbalance in a transformer area; wherein the split-phase power adjustment modules are connected to lines of three phases A, B, and C and a neutral line N in the transformer area; wherein the sub-controllers are connected to the adjustment power supplies, and the sub-controllers communicate with the main controller to control power generated by each of the adjustment power supplies, so as to compensate the unbalanced three-phase current in the transformer area. Coordinated adjustment of multiple distributed power supplies realizes precise control of three-phase imbalance in the transformer area, which reduces line loss and improves power quality.

### TECHNICAL FIELD

The present invention relates to the field of electric energy quality control of electric power systems, in particular to a split-phase output power adjustment system, adjustment method, and storage medium in a low voltage transformer area.

### BACKGROUND

High-quality power quality is a prerequisite for ensuring high-quality and economical power supply to users. With the development of society and the improvement of people's living standards, both production enterprises and residents have increasingly high demands for power quality. In the domestic distribution network, with respect the low voltage transformer area, three-phase and four-wire power supply is adopted. However, due to the irregular connection of single-phase loads and inconsistent timing of electricity usage, the three-phase balance of the distribution network system is generally results in imbalance. Currently, a large number of distributed low-voltage photovoltaic devices are added to the distribution network transformer stations, resulting in further exacerbated three-phase imbalance. This issue has led to increasing problems such as lower voltage and line-loss increasing; and in severe cases, it causes single-phase overload and burnout of distribution transformers, affecting electricity consumption from residents' normal production and their living.

So far, to address the issue of three-phase imbalance in the distribution network, a patent application, CN105406494 “a current compensation method and device for three-phase unbalanced in a low-voltage power grid”, proposes a method for compensating zero-sequence current using single-phase APF active filters to output current values opposite in direction but equal in magnitude to phase currents. Another patent application, CN21404544U “a device for managing three-phase imbalance in low-voltage lines based on a three-phase and four-wire photovoltaic inverter,” proposes, which proposes a method utilizing a dedicated photovoltaic inverter applying three-phase and four-wire. This method involves connecting the input switch to the phase with a light grid load and connecting the output switch to the phase with a heavy grid load. This facilitates the adjustment of power balance between the two phases of the light load and the heavy load, which aims to address three-phase imbalance. However, the aforementioned methods have a significant drawback: it is unable to completely suppress negative-sequence and zero-sequence currents on the line so it cannot achieve complete compensation for unbalanced currents. Instead, such the methods can only partially reduce system imbalance to a certain extent, rendering it unable to achieve complete three-phase balance for distribution transformers.

### SUMMARY OF INVENTION

A series of concepts in simplified form are introduced in the summary of the invention, which will be further detailed in the detailed description. The summary of the invention in the present invention does not mean to limit the key features and essential technical features of the claimed technical solution and does not mean to try to determine the protection scope of the claimed technical solution.

In order to overcome the defects of the prior art and effectively solve the unbalanced three-phase problem of the distribution network, in the first aspect of the present invention, a split-phase output power adjustment system in a low voltage transformer area is provided, including:

adjustment power supplies 10, split-phase power adjustment modules 20, sub-controllers 30, a main controller 40;

the adjustment power supplies are connected to the split-phase power adjustment modules, and the total power P of the adjustment power supplies complies with the following relationship:

$$P = {P}_{t} = {P}_{G 1} + {P}_{G 2} + {⋯P}_{Gn}$$

where Pₜ is the power required to comply with the three-phase current unbalance adjustment of the distribution transformer, P_{G1}, P_{G2}, . . . . P_{Gn} is the power generated by each of the adjustment power supplies to compensate the three-phase current unbalance in the transformer area;

the split-phase power adjustment modules are connected to the lines of three phases A, B, and C and the neutral line N in the transformer area;

the sub-controllers are connected to the adjustment power supplies, and the sub-controllers communicate with the main controller to control the power generated by each of the adjustment power supplies, so as to compensate the unbalanced three-phase current in the transformer area.

Optionally, the split-phase power adjustment modules include a first filter capacitor, a second filter capacitor, a three-phase reactor, and a three-phase full-bridge inverter;

the first filter capacitor and the second filter capacitor are connected to the power grid between the neutral line of the power grid and the three-phase full-bridge inverter, and the three-phase reactor is connected between the three-phase full-bridge inverter and the three-phase line of the power grid;

wherein the inductance values of the first filter capacitor, the second filter capacitor and the three-phase reactor are determined by capacity and filter effect thereof.

Optionally, the sub-controllers communicate with the main controller via wireless or carrier wave, and the sub-controllers are electrically connected to the split-phase power adjustment modules, and are used for collecting the power and voltage of each phase of the corresponding split-phase power adjustment modules connected to the grid-point, so as to upload them to the main controller. The sub-controllers send the control amount calculated by the main controller to the corresponding split-phase power adjustment modules, so as to control the split-phase power adjustment modules to output the adjustment power corresponding to the main controller.

Optionally, the main controller is used to collect voltage and current of phase A, phase B, and phase C in the transformer area, and calculate the three-phase power of the phase A, the phase B, and the phase C to be outputted by the split-phase power adjustment modules according to the voltage and current of the phase A, the phase B, and the phase C;

wherein the power calculation formulas of the phase A, the phase B, and the phase C are as follows:

$$\begin{matrix}{P}_{a} = {u}_{a} * {i}_{a} \\ {P}_{b} = {u}_{b} * {i}_{b} \\ {P}_{c} = {u}_{c} * {i}_{c}\end{matrix}$$

In the formula, Pa is the power of the phase A in the transformer area, Ua is the voltage of the phase A at the head end in the transformer area, ia is the current of the phase A at the head end in the transformer area, P_{b} is the power of the phase B in the transformer area, U_{b} is the voltage of the phase B at the head end in the transformer area, i_{b} is the current of the phase B at the head end in the transformer area, P_{b} is the power of the phase B in the transformer area, U_{b} is the voltage of the phase B at the head end in the transformer area, and it is the current of the phase B at the head end in the transformer area;

The formula for calculating the power that the j-th adjustment power supply after the node i needs to compensate to the three phases A, B, and C in the transformer area is as follows:

$$\begin{matrix}{\sum }_{j = 1}^{n} \vert {P}_{axj} \vert = \frac{{P}_{a} + {P}_{b} + {P}_{c}}{3} - {P}_{a} \\ {\sum }_{j = 1}^{n} \vert {P}_{bxj} \vert = \frac{{P}_{a} + {P}_{b} + {P}_{c}}{3} - {P}_{b} \\ {\sum }_{j = 1}^{n} \vert {P}_{cxj} \vert = \frac{{P}_{a} + {P}_{b} + {P}_{c}}{3} - {P}_{c}\end{matrix}$$

In the formula, n is the number of the adjustment power supplies participating in the adjustment.

Optionally, as the split-phase power adjustment modules ensure the minimum voltage difference among the nodes, the optimal output values of Pxa, Pxb, Pxc, Qxa, Qxb, and Qxc of the split-phase power adjustment modules are obtained according to the PSO optimization algorithm;

wherein the imbalance degree formulas corresponding to the PSO optimization algorithm are:

$$( Pa + Pb + Pc - ( Pxa + pxb + pxc ) ) / 3 = K 1 ;$$

$$( \vert Pa - Pxa - K 1 \vert + \vert pb - Pxb - K 1 \vert + \vert Pc - Pxc - K 1 \vert ) / 3 * K 1 = A ;$$

The constraints corresponding to the PSO optimization algorithm are:

$$pxa + Pxb + Pxc = Ppv$$

$$Pxa + pxb + pxc + Qx \leq Svsi$$

$$A < 5 \%$$

The objective formulas corresponding to the PSO optimization algorithm are:

$$Min {\sum }_{j = 1}^{k} △ {U}_{mj} △ {U}_{m} = {U}_{m} - {U}_{m - 1} = - \frac{[ {\sum }_{i = m}^{K} ( {P}_{i} - \vert {P}_{xi} \vert ) ] {rl}_{m} + [ {\sum }_{i = m}^{K} ( {Q}_{i} ) ] {xl}_{m}}{{U}_{m - 1}}$$

In the formula, ΔUₘⱼ is the voltage difference between the node m and the node m-1 after the distributed power supplies and the energy storage participate in the unbalanced adjustment, k is the total number of the adjustment power supplies connected to the transformer area, Pi is the power of each node in the transformer area after the node i, r is the resistance corresponding to the line per unit length in the transformer area, x is the reactance corresponding to the line per unit length in the transformer area, and lm is the length of the line from the head end in the transformer area to the node i.

Optionally, under the condition that the split-phase power adjustment modules ensure that the distributed photovoltaic power supplies operate in the maximum power generation mode, the unbalanced reference currents I_{a_ref}, I_{b_ref}, I_{c_ref} of the output of the split-phase power adjustment modules are determined by the following formulas:

$$\begin{matrix}{I}_{a\_ref} = {I}_{a}^{-} + {I}_{a}^{0} + {Ia}^{*} \\ {I}_{b\_ref} = {I}_{b}^{-} + {I}_{b}^{0} + {Ib}^{*} \\ {I}_{c\_ref} = {I}_{c}^{-} + {I}_{c}^{0} + {Ic}^{*}\end{matrix}$$

In the formula, Iₐ⁻, I_{b}⁻, I_{c}⁻, Iₐ⁰, I_{b}⁰, I_{c}⁰ represent the negative sequence current and zero sequence current of the required compensating currents obtained through the decomposition calculation of the unbalanced current sequence components that the split-phase power adjustment modules output, Ia*, Ib*, and Ic* are the control components of the filter capacitor voltage of the split-phase power adjustment modules.

Optionally, the control components of the filter capacitor voltage of the split-phase power adjustment modules are Ia*, Ib*, Ic* and are obtained by the following method:

obtaining the voltage difference between the voltage U_{dc} and U_{dc_ref} at the positive and negative terminals of the first filter capacitor and the second filter capacitor connected in series;

outputting the voltage difference after passing by the PI controller as the d-axis active components of the dq/abc transformation;

setting the q-axis reactive components of the dq/abc transformation to 0;

obtaining the capacitance voltage control components Ia*, Ib* and Ic* from the dq/abc transformation.

Optionally, the unbalanced currents output by the split-phase power adjustment modules are determined by the following formulas:

$$\begin{matrix}{I}_{aj} = \vert {P}_{axj} \vert / {u}_{aj} \\ {I}_{bj} = \vert {P}_{bxj} \vert / {u}_{bj} \\ {I}_{cj} = \vert {P}_{cxj} \vert / {u}_{cj}\end{matrix}$$

In the formula, uₐⱼ, u_{bj}, u_{cj} are voltages of the three phases A, B, C at the node j, respectively.

In the second aspect, the present invention further proposes a split-phase output power adjustment method in a low voltage transformer area, including: step S110-step S170;

S110, detecting a three-phase unbalance degree;

S120, at a condition that the three-phase unbalance degree does not reach a starting value, calculating power to be compensated for each phase in a transformer area;

S130, determining an adjustment power supply that needs to participate in unbalanced adjustment in the transformer area, in which the adjustment power supply includes distributed photovoltaic devices and distributed small energy storage power supplies in the transformer area;

S140, calculating an unbalanced adjustment power to be output by each split-phase power adjustment module, and determining three-phase compensation reference currents I_{a_ref}, I_{b_ref}, I_{c_ref} of the split-phase power adjustment modules;

S150, obtaining actual compensation currents Iₒₐ, I_{ob}, I_{oc} of converters of phase output modules by tracking the current reference values I_{a_ref}, I_{b_ref}, I_{c_ref} through hysteresis control of the converters of the split-phase power adjustment modules;

S160, detecting whether a change range of the three-phase unbalance degree reaches a set offset value;

S170, if the set offset value has not been reached, repeating the steps S120 to S160.

In the third aspect, the present invention further proposes a computer-readable storage medium on which a computer program is stored. The computer program, when executed by a processor, realizes the split-phase output power adjustment method in the low voltage transformer area as described in the second aspect.

Embodiments of the present invention can be applied for achieving the following advantageous effects:

By controlling multiple distributed adjustment power supplies in the transformer area, which include distributed photovoltaic devices and a distributed small energy storage power supply, at a condition that the minimum voltage deviation in the transformer area is ensured, outputting unbalanced currents under the conditions of the multiple distributed power supplies collaboration for coordinated adjustment, precise control of three-phase unbalance in the transformer area is achieved. This effectively reduces line lose and improves the quality of electric energy. The present invention achieves the optimal power generation of distributed photovoltaic power supplies and the compensation for three-phase unbalance in the transformer area. When the three-phase loads are balanced in the transformer area, the photovoltaic power supplies can supply power to the loads as normal power supplies, enhancing the economic feasibility of the system. When the three-phase unbalance occurs in the transformer area, multiple distributed photovoltaic power supplies can be controlled to output three-phase unbalance compensation power and generation power, taking into account both the control of three-phase unbalance in the transformer area and the grid connection of photovoltaic power generation. It provides a novel method for distributed power supplies participating in the power adjustment in the transformer area, which can support the construction of new power systems. It realizes the governance of multi-distributed photovoltaic power generation split-phase grid connection and three-phase imbalance distribution and transformation. A mode in which multiple distributed power supplies cooperate to participate in the control of the transformer area is proposed, which provides a reference control technology for the power disturbance in the transformer area caused by the high penetration of distributed photovoltaic power supplies under the new power systems.

### BRIEF DESCRIPTION OF DRAWINGS

In order to provide a clearer explanation of the technical solutions in the embodiments of the present invention or the prior art, a brief introduction to the drawings required in the description of the embodiments or the prior art will be provided below. Clearly, the drawings described below are only for some embodiments of the present invention. Those skilled in the art will understand that additional drawings can be obtained based on these drawings without creative effort.

Among the drawings:

FIG. 1 is a schematic diagram of a split-phase output power adjustment system in a low voltage transformer area according to an embodiment of the present invention;

FIG. 2 is a structural diagram of a split-phase power adjustment module according to an embodiment of the present invention;

FIG. 3 is a control block diagram of an unbalanced current output method of a split-phase power adjustment module according to an embodiment of the present invention;

FIG. 4 is a waveform diagram of a three-phase unbalanced current on the back-end load side according to an embodiment of the present invention;

FIG. 5 is a waveform diagram of a three-phase unbalanced current on the front-end load side according to an embodiment of the present invention;

FIG. 6 is a waveform diagram of the output current of a three-phase full-bridge inverter according to an embodiment of the present invention;

FIG. 7 is a waveform diagram for a current of an electrical transmission line before compensation according to an embodiment of the present invention;

FIG. 8 is a waveform diagram for a current of an electrical transmission line after compensation according to an embodiment of the present invention;

FIG. 9 is a flowchart of a split-phase output power adjustment method in a low voltage transformer area according to an embodiment of the present invention;

FIG. 10 is a structural diagram of an electronic equipment for low-voltage crossing control of a direct-drive fan according to an embodiment of the present application.

### DETAILED DESCRIPTION OF THE INVENTION

The following will clearly and completely describe the technical solutions in the embodiments of the present invention with reference to the accompanying drawings in the embodiments of the present invention. Obviously, the described embodiments are only some embodiments of the present invention but not all. Based on the embodiments of the present invention, all other embodiments obtained by persons of ordinary skill in the art without creative efforts fall within the protection scope of the present invention.

The terms “first’, “second”, “third”, “fourth”, etc. (if any) in the description and claims of the present application and the above drawings are used to distinguish similar objects, and not necessarily used for describing a specific sequence or sequence. It is to be understood that the terms so used are interchangeable under appropriate circumstances such that the embodiments described herein can be practiced in sequences other than those illustrated or described herein. Furthermore, the terms “comprising” and “having”, as well as any variations thereof, are intended to cover a non-exclusive inclusion; for example, a process, method, system, product or device comprising a sequence of steps or elements is not necessarily limited to the expressly listed instead, may include other steps or elements not explicitly listed or inherent to the process, method, product or apparatus. The following will clearly and completely describe the technical solutions in the embodiments of the application with reference to the drawings in the embodiments of the present application. Apparently, the described embodiments are only some of the embodiments of the present application, not all of them.

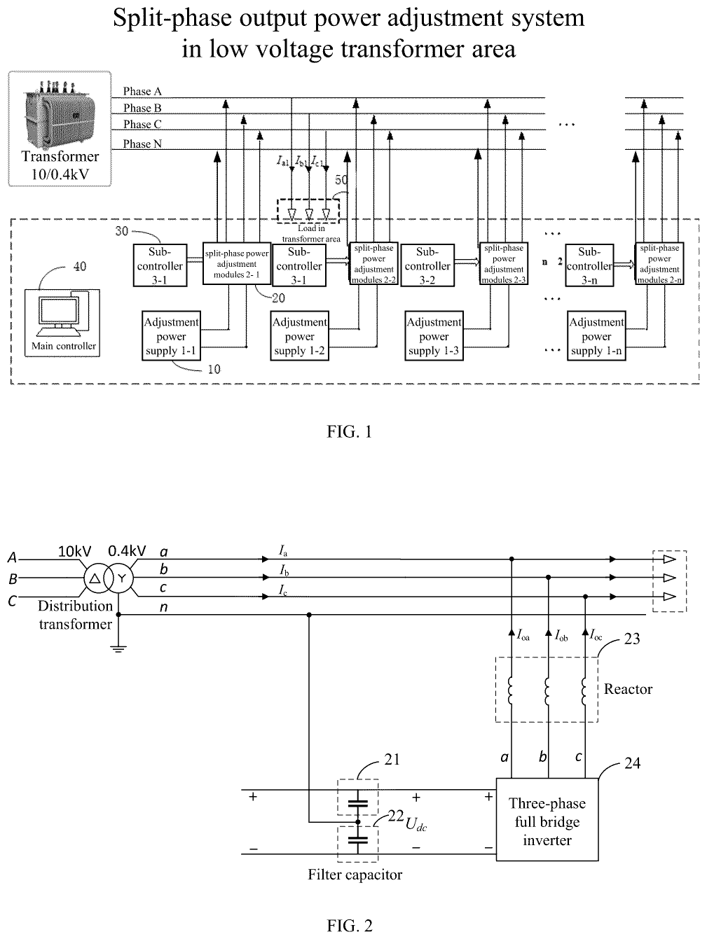

Referring to FIG. 1, which is a split-phase output power adjustment system in a low voltage transformer area according provided by an embodiment of the present invention, including:

adjustment power supplies 10, split-phase power adjustment modules 20, sub-controllers 30, a main controller 40;

the adjustment power supplies 10 are connected to the split-phase power adjustment modules 20, and the total power P of the adjustment power supplies complies with the following relationship:

$$P = {P}_{t} = {P}_{G 1} + {P}_{G 2} + {⋯P}_{Gn}$$

where Pₜ is the power required to comply with the three-phase current unbalance adjustment of the distribution transformer, P_{G1}, P_{G2}, . . . P_{Gn} is the power generated by each of the adjustment power supplies 10 to compensate the three-phase current unbalance in the transformer area;

the split-phase power adjustment modules 20 are connected to the lines of three phases A, B, and C and the neutral line N in the transformer area;

the sub-controllers 30 are connected to the adjustment power supplies 10, and the sub-controllers 30 communicate with the main controller 10 to control the power generated by each of the adjustment power supplies 10, so as to compensate the unbalanced three-phase current in the transformer area.

Specifically, as shown in FIG. 1, the main controller 40 controls a plurality of split-phase power adjustment modules 20 to control the power of each adjustment power supply 10 input to the power grid in the transformer area. The adjustment power supplies 10 include power supplies such as distributed photovoltaic devices in the transformer area, distributed small hydropower, diesel generators, and distributed energy storage. Pₜ is to meet the power required for the three-phase current imbalance adjustment of distribution transformers, and the adjustment power supplies send energy to the transformer area to compensate for the three-phase current imbalance in the transformer area. When the adjustment power supplies compensate the three-phase current imbalance in the transformer area, it can be achieved by that the adjustment power supplies at some nodes can send energy to the transformer area, or that the adjustment power supplies at all nodes can send energy to the transformer area. The sub-controllers 30 are connected between the adjustment power supply connection 10 and the power grid in the transformer area through wires. The main controller 10 obtains the voltage and power measured at its access according to the split-phase power adjustment modules 20, and transmits the above-mentioned voltage and power to the main controller 10, and then the main controller 10 sends the control amount to the corresponding the split-phase power adjustment modules 20, thereby controlling the phase output module to output the adjustment power corresponding to the main controller.

In some embodiments, the split-phase power adjustment modules include a first filter capacitor 21, a second filter capacitor 22, a three-phase reactor 23, and a three-phase full-bridge inverter 24;

the first filter capacitor 21 and the second filter capacitor 22 are connected to the power grid between the neutral line of the power grid and the three-phase full-bridge inverter 24, and the three-phase reactor 23 is connected between the three-phase full-bridge inverter 24 and the lines of three phases A,B, C of the power grid;

wherein the inductance values of the first filter capacitor 21, the second filter capacitor 22 and the three-phase reactor 23 are determined by capacity and filter effect thereof.

In some embodiments, the sub-controllers 30 communicate with the main controller 40 via wireless or carrier wave, and the sub-controllers 30 are electrically connected to the split-phase power adjustment modules 20, and are used for collecting the power and voltage of each phase of the corresponding split-phase power adjustment modules 20 connected to the grid-point, so as to upload them to the main controller 40. The sub-controllers 30 send the control amount calculated by the main controller 40 to the corresponding split-phase power adjustment modules 20, so as to control the split-phase power adjustment modules 20 to output the adjustment power corresponding to the main controller.

In some embodiments, the main controller 40 is used to collect voltage and current of the phase A, the phase B, and the phase C in the transformer area, and calculate the three-phase power of the phase A, the phase B, and the phase C to be outputted by the split-phase power adjustment modules according to the voltage and current of the phase A, the phase B, and the phase C;

wherein the power calculation formulas of the phase A, the phase B, and the phase C are as follows:

$$\begin{matrix}{P}_{a} = {u}_{a} * {i}_{a} \\ {P}_{b} = {u}_{b} * {i}_{b} \\ {P}_{c} = {u}_{c} * {i}_{c}\end{matrix}$$

In the formula, Pa is the power of the phase A in the transformer area, Ua is the voltage of the phase A at the head end in the transformer area, ia is the current of the phase A at the head end in the transformer area, P_{b} is the power of the phase B in the transformer area, U_{b} is the voltage of the phase B at the head end in the transformer area, i_{b} is the current of the phase B at the head end in the transformer area, P_{b} is the power of the phase B in the transformer area, U_{b} is the voltage of the phase B at the head end in the transformer area, and it is the current of the phase B at the head end in the transformer area;

The formula for calculating the power that the j-th adjustment power supply after the node i needs to compensate to the three phases A, B, and C in the transformer area is as follows:

$${\sum }_{j = 1}^{n} \vert {P}_{axj} \vert = \frac{{P}_{a} + {P}_{b} + {P}_{c}}{3} - {P}_{a} \\ {\sum }_{j = 1}^{n} \vert {P}_{bxj} \vert = \frac{{P}_{a} + {P}_{b} + {P}_{c}}{3} - {P}_{b} \\ {\sum }_{j = 1}^{n} \vert {P}_{cxj} \vert = \frac{{P}_{a} + {P}_{b} + {P}_{c}}{3} - {P}_{c}$$

In the formula, n is the number of the adjustment power supplies participating in the adjustment.

In some embodiments, as the split-phase power adjustment modules ensure the minimum voltage difference among the nodes, the optimal output values of Pxa, Pxb, Pxc, Qxa, Qxb, and Qxc of the split-phase power adjustment modules are obtained according to the PSO optimization algorithm;

wherein the imbalance degree formulas corresponding to the PSO optimization algorithm are:

$$( Pa + Pb + Pc - ( Pxa + pxb + pxc ) ) / 3 = K 1 ; \\ ( \vert Pa - Pxa - K 1 \vert + \vert pb - Pxb - K 1 \vert + \vert Pc - Pxc - K 1 \vert ) / 3 * K 1 = A ;$$

The constraints corresponding to the PSO optimization algorithm are:

$$pxa + Pxb + Pxc = Ppv \\ Pxa + pxb + pxc + Qx \leq Svsi \\ A < 5 \%$$

The objective formulas corresponding to the PSO optimization algorithm are:

$$M in {\sum }_{j = 1}^{k} Δ {U}_{mj} \\ Δ {U}_{m} = {U}_{m} - {U}_{m - 1} = - \frac{[ {\sum }_{i = m}^{K} ( {P}_{i} - \vert {P}_{xi} \vert ) ] {rl}_{m} + [ {\sum }_{i = m}^{K} ( {Q}_{i} ) ] {xl}_{m}}{{U}_{m - 1}}$$

In the formula, ΔUₘⱼ is the voltage difference between the node m and the node m-1 after the distributed power supplies and the energy storage participate in the unbalanced adjustment, k is the total number of the adjustment power supplies connected to the transformer area, Pi is the power of each node in the transformer area after the node i, r is the resistance corresponding to the line per unit length in the transformer area, x is the reactance corresponding to the line per unit length in the transformer area, and lm is the length of the line from the head end in the transformer area to the node i.

In some embodiments, under the condition that the split-phase power adjustment modules 20 ensure that the distributed photovoltaic power supplies operate in the maximum power generation mode, the unbalanced reference currents I_{a_ref}, I_{b_ref}, I_{c_ref} of the output of split-phase power adjustment modules 20 are determined by the following formulas:

$${I}_{a \_ ref} = {I}_{a}^{-} + {I}_{a}^{0} + {Ia}^{*} \\ {I}_{b \_ ref} = {I}_{b}^{-} + {I}_{b}^{0} + {Ib}^{*} \\ {I}_{c \_ ref} = {I}_{c}^{-} + {I}_{c}^{0} + {Ic}^{*}$$

In the formula, Iₐ⁻, I_{b}⁻, I_{c}⁻, Iₐ⁰, I_{b}⁰, I_{c}⁰ represent the negative sequence current and zero sequence current of the required compensating currents obtained through the decomposition calculation of the unbalanced current sequence components that the split-phase power adjustment modules 20 output, Ia*, Ib*, and Ic* are the control components of the filter capacitor voltage of the split-phase power adjustment modules.

In some embodiments, the control components of the filter capacitor voltage of the split-phase power adjustment modules 20 are Ia*, Ib*, Ic* and are obtained by the following method:

obtaining the voltage difference between the voltage U_{dc} and U_{dc_ref} at the positive and negative terminals of the first filter capacitor and the second filter capacitor connected in series;

outputting the voltage difference after passing by the PI controller as the d-axis active components of the dq/abc transformation;

setting the q-axis reactive components of the dq/abc transformation to 0;

obtaining the capacitance voltage control components Ia*, Ib* and Ic* from the dq/abc transformation.

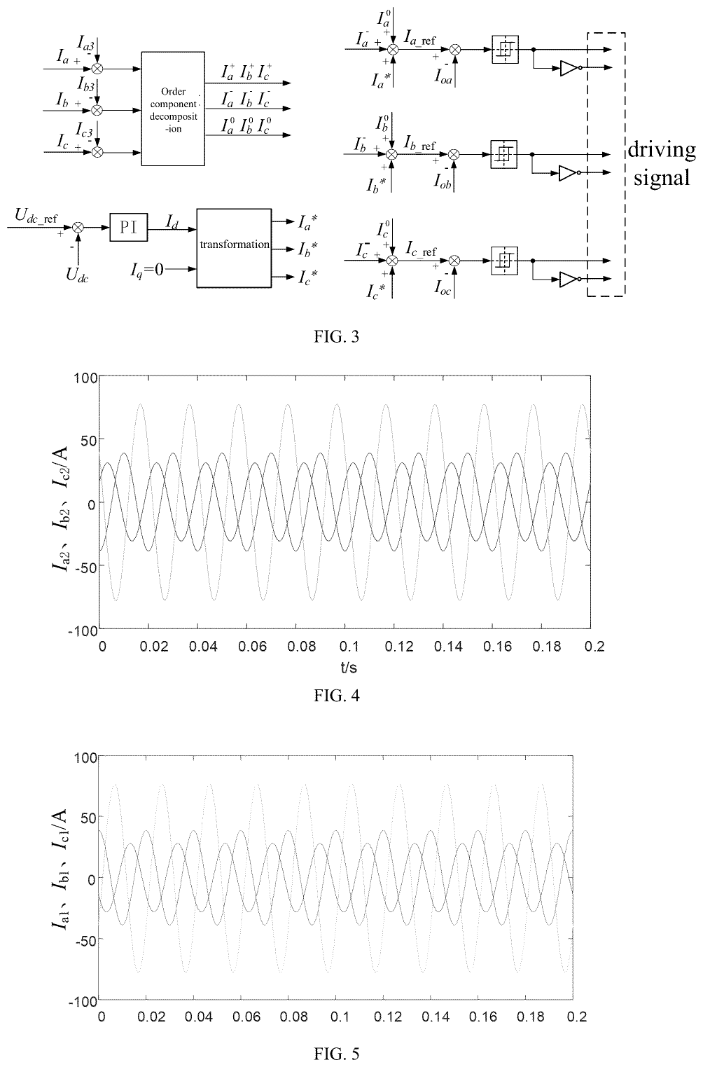

Specifically, FIG. 3 is a control block diagram of an unbalanced current output method of a split-phase power adjustment module 20 according to an embodiment of the present invention. First, the voltage U_{dc} of the first filter capacitor and the voltage U_{dc_ref} of the second filter capacitor are calculated for the difference therebetween, and then the difference is output as the d-axis active component I_{d} of the dq/abc transformation after passing by the PI controller; the q-axis reactive component I_{q} of the dq/abc transformation is set to 0, and the control components Ia*, Ib*, and Ic* of the capacitance voltage are obtained by transforming the active component I_{d} and the reactive component I_{q} using the dq/abc transformation.

In some embodiments, the unbalanced currents output by the split-phase power adjustment modules 20 are determined by the following formulas:

$${I}_{aj} = \vert {P}_{axj} \vert / {u}_{aj} \\ {I}_{bj} = \vert {P}_{bxj} \vert / {u}_{bj} \\ {I}_{cj} = \vert {P}_{cxj} \vert / {u}_{cj}$$

In the formula, uaj, ubj, ucj are voltages of the three phases A, B, C at the node j, respectively.

As described above, in the present invention, by controlling multiple distributed adjustment power supplies in the transformer area, at a condition that the minimum voltage deviation in the transformer area is ensured, outputting unbalanced currents under the conditions of the multiple distributed power supplies collaboration for coordinated adjustment, precise control of three-phase unbalance in the transformer area is achieved. This effectively reduces line lose and improves the quality of electric energy. The present invention achieves the optimal power generation of distributed photovoltaic power supplies and the compensation for three-phase unbalance in the transformer area. When the three-phase loads are balanced in the transformer area, the photovoltaic power supplies can supply power to the loads as normal power supplies, enhancing the economic feasibility of the system. When the three-phase unbalance occurs in the transformer area, the multiple distributed photovoltaic power supplies can be controlled to output three-phase unbalance compensation power and generation power, taking into account both the control of three-phase unbalance in the transformer area and the grid connection of photovoltaic power generation. It provides a novel method for distributed power supplies participating in the power adjustment in the transformer area, which can support the construction of new power systems. It realizes the governance of multi-distributed photovoltaic power generation split-phase grid connection and three-phase imbalance distribution and transformation. A mode in which multiple distributed power supplies cooperate to participate in the control of the transformer area is proposed, which provides a reference control technology for the power disturbance in the transformer area caused by the high penetration of distributed photovoltaic power supplies under the new power systems.

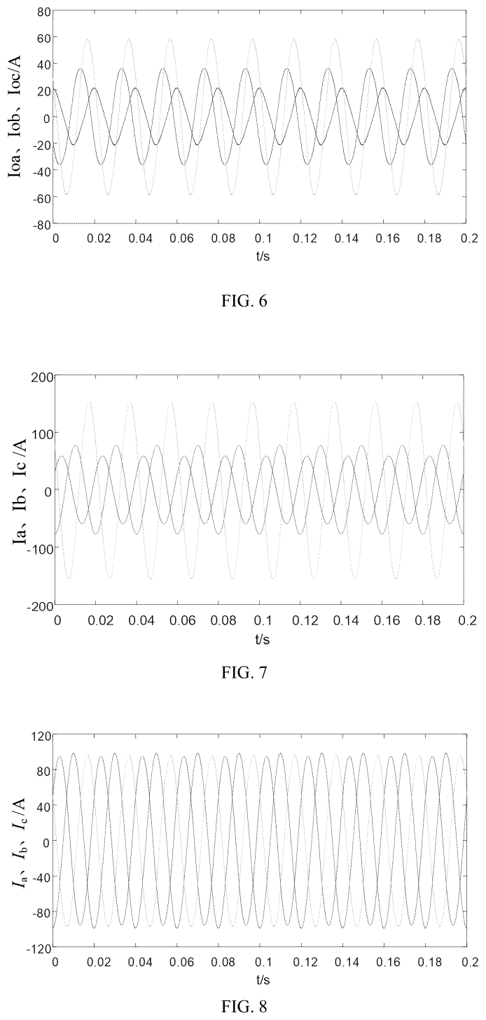

Referring to FIG. 4 to FIG. 9, FIG. 4 is a waveform diagram of a three-phase unbalanced current on the back-end load side. Its waveform indicates that the three-phase current at the back-end load side is in an unbalanced state. FIG. 5 is a waveform diagram of a three-phase unbalanced current on the front-end load side. Its waveform indicates that the three-phase current at the front-end load side is in an unbalanced state. FIG. 6 is a waveform diagram of the output current of a three-phase full-bridge inverter. Its waveform is the compensation current output by the three-phase full-bridge inverter using the control method provided by the present invention. FIG. 7 is a waveform diagram for a current of an electrical transmission line before compensation. It can be found from the illustration that the three-phase current of the transmission line is in an unbalanced state, and the current unbalanced degree is 37.2%. FIG. 8 is a waveform diagram for a current of an electrical transmission line after compensation. It can be found from the illustration that the three-phase current of the transmission line is in a balanced state, and the current unbalanced degree is 1.8%.

It can be found from the current waveform diagram that, by using the split-phase output power adjustment system in the low voltage transformer area provided by the present invention, the current imbalance degree is significantly reduced, which provides a base of a control technology for the power disturbance in the transformer area caused by the high penetration of distributed photovoltaic power supplies under the new power systems.

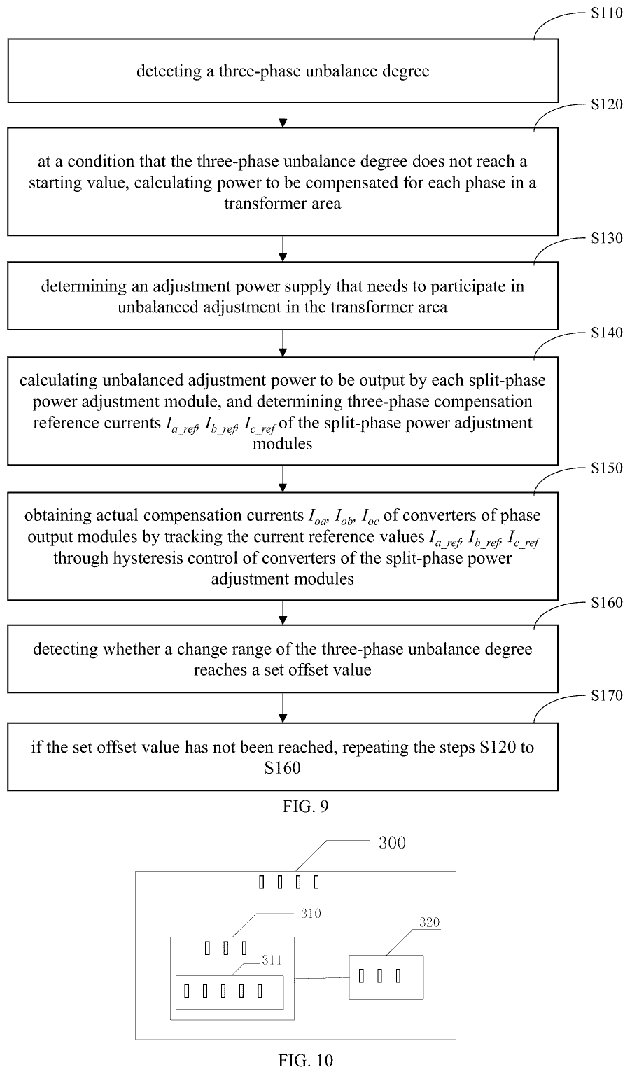

FIG. 9 is a flowchart of a split-phase output power adjustment method in a low voltage transformer area, which is used for the system of the first aspect, provided by the present disclosure, characterized by including:

S110, detecting a three-phase unbalance degree;

S120, at a condition that the three-phase unbalance degree does not reach a starting value, calculating power to be compensated for each phase in a transformer area;

S130, determining distributed photovoltaic devices that needs to participate in unbalanced adjustment in the transformer area;

S140, calculating an unbalanced adjustment power to be output by each split-phase power adjustment module, and determining three-phase compensation reference currents I_{a_ref}, I_{b_ref}, I_{c_ref} of the split-phase power adjustment modules;

S150, obtaining actual compensation currents Iₒₐ, I_{ob}, I_{oc} of converters of phase output modules by tracking the current reference values I_{a_ref}, I_{b_ref}, I_{c_ref} through hysteresis control of the converters of the split-phase power adjustment modules;

S160, detecting whether a change range of the three-phase unbalance degree reaches a set offset value;

S170, if the set offset value has not been reached, repeating the steps S120 to S160.

Referring to FIG. 10, in an embodiment of the present application, an electronic apparatus 300 is provided, including a memory 310, a processor 320, and a computer program 311 that is stored in the memory 320 and is operable on the processor. When the processor 320 executes the computer program 311, the steps of anyone method as described above for the temperature control of the outlet of a trough solar collector site can be achieved.

Since the electronic apparatus introduced in this embodiment is the equipment used to implement the outlet temperature control device of a trough solar collector site in the embodiment of the present application, based on the method described in the embodiments of the present application, those skilled in the art can understand the specific implementation of the electronic apparatus of the present embodiment and its various variations. Therefore, how the electronic apparatus implements the method in the embodiment of the present application is not described in detail herein. As long as a person skilled in the art implements the apparatus used by the method in the embodiment of the present application, it all belongs to the protection scope of the present application.

In a specific implementation process, when the computer program 311 is executed by a processor, any implementation manner in the embodiment corresponding to FIG. 9 can be implemented.

Those skilled in the art should understand that the embodiments of the present application can provide methods, systems, or computer program products. Therefore, the present application can be implemented in the form of fully hardware embodiments, fully software embodiments, or embodiments that combine software and hardware aspects. Additionally, the present application can be implemented in the form of a computer program product with computer-executable program code stored on one or more computer-readable storage media (which including but not limited to magnetic storage, CD-ROMs, optical storage, etc.).

This present application is described with reference to flowcharts and/or block diagrams illustrating methods, apparatus (systems), and computer program products according to embodiments of the present application. It should be understood that each process and/or block shown in the flowcharts and/or block diagrams can be implemented by computer program instructions. These computer program instructions can be provided to a general computer, a special computer, an embedded computer, or other programmable data processing devices' processors to create a machine that executes instructions performed by a computer or other programmable data processing devices' processor to realize the functionality specified in one or more processes in the flowcharts or one or more blocks in the block diagrams.

These computer program instructions can also be stored in computer-readable memory that can boot a computer or other programmable data processing devices to operate in a specific manner, creating a manufactured product that includes an instruction device. This instruction device implements the functionality specified in one or more processes in the flowcharts or one or more blocks in the block diagrams.

These computer program instructions can also be loaded onto a computer or other programmable data processing device, causing a series of operational steps to be performed on the computer or other programmable device to produce a computer-implemented process. As such, instructions executed on computers or other programmable devices provide steps for realizing the functions specified in one or more processes of the flowchart and/or one or more blocks of the block diagram.

The embodiments of the present application further provide a computer program product comprising computer software instructions. When these computer software instructions are executed by a processing device, the processing device executes the flow of the low-voltage ride-through control method of the direct-drive fan in the corresponding embodiment as shown in FIG. 1.

The computer program product includes one or more computer instructions. When loaded and executed on a computer, the computer program instructions generate all or part of the process or functionality according to the embodiments of the present application. The computer can be a general computer, a specialized computer, a computer network, or other programmable devices. Computer instructions can be stored in computer-readable storage media or transferred from one computer-readable storage medium to another. For example, computer instructions can be transmitted from a website site, computer, server, or data center to another website site, computer, server or data center for transmission, by a wired way (e.g., coaxial cable, optical fiber, digital subscriber line (DSL)) or a wireless way (e.g., infrared, wireless, microwave, etc.). The computer-readable storage medium may be any available medium that can be stored by a computer, or a data storage device such as a server, a data center, etc. integrated with one or more available media. The usable medium may be a magnetic medium (for example, a floppy disk, a hard disk, or a magnetic tape), an optical medium (for example, DVD), or a semiconductor medium (for example, a solid state disk (solid state disk, SSD)), etc.

Those skilled in the art of the relevant field can clearly understand that for the sake of convenience and conciseness, the specific operational processes of the described systems, devices, and units can be referred to the corresponding processes in the previous method embodiments, and are not reiterated here.

In several embodiments provided in the present application, it should be understood that the disclosed systems, devices, and methods can be implemented in other ways. For example, the described device embodiments are only illustrative. The division of units, such as the segmentation of units, is just a logical functional division, and actual implementation can involve alternative divisions. Multiple units or components can be combined or integrated into another system, and certain features can be ignored or left unexecuted. Additionally, the displayed or discussed couplings, direct couplings, or communication connections between elements can also be indirect couplings or communication connections through interfaces, devices, or units, and these connections can be electrical, mechanical, or of other forms.

Units described as separate components can physically be separate or not. Units displayed as individual components can be physical units or not, meaning they can be located in one place or distributed across multiple network units. Depending on the specific requirements, some or all of the units can be selected to achieve the purpose of the embodiments.

Furthermore, functional units in various embodiments of the present application can be integrated into one processing unit, or they can physically exist as separate units or integrated within one unit. These integrated units can be implemented in hardware form or as software functional units.

If the integrated units are implemented in the form of software functional units and sold or used as standalone products, they can be stored in a computer-readable storage medium. Based on this understanding, the technological aspects of this application, which essentially contribute to or fully or partially embody the solutions, can also be embodied in the form of software products. These computer software products are stored in a storage medium and include instructions to enable a computing device (which can be a personal computer, server, or network device, among others) to execute all or part of the steps of the various embodiments described in this application. The aforementioned storage media can include USB drives, external hard drives, Read-Only Memory (ROM), Random Access Memory (RAM), magnetic disks, optical disks, and various other media capable of storing program code.

The above-disclosed embodiments represent preferred embodiments of the present invention. However, these embodiments should not be seen as limiting the scope of the present invention. Therefore, any equivalent changes made in accordance with the claims of the present invention are still within the scope of the present invention.

What is claimed is:

1. A split-phase output power adjustment system in a low voltage transformer area, comprising adjustment power supplies, split-phase power adjustment modules, sub-controllers, and a main controller;
the adjustment power supplies connected to the split-phase power adjustment modules, and total power P of the adjustment power supplies complying with a relationship as follows:
$$P = {P}_{t} = {P}_{G 1} + {P}_{G 2} + … {P}_{Gn}$$
wherein Pₜ is power required to comply with three-phase current unbalance adjustment of a distribution transformer, P_{G1}, P_{G2}, . . . P_{Gn} is power generated by each of the adjustment power supplies to compensate three-phase current unbalance in a transformer area;
wherein the split-phase power adjustment modules are connected to lines of three phases A, B, and C and a neutral line N in the transformer area;
wherein the sub-controllers are connected to the adjustment power supplies, and the sub-controllers communicate with the main controller to control power generated by each of the adjustment power supplies, so as to compensate the unbalanced three-phase current in the transformer area.

2. The system of claim 1, wherein, the split-phase power adjustment modules comprise a first filter capacitor, a second filter capacitor, a three-phase reactor, and a three-phase full-bridge inverter;
wherein the first filter capacitor and the second filter capacitor are connected to a power grid between the neutral line of the power grid and the three-phase full-bridge inverter, and the three-phase reactor is connected between the three-phase full-bridge inverter and a three-phase line of the power grid;
wherein inductance values of the first filter capacitor, the second filter capacitor and the three-phase reactor are determined by capacity and filter effect thereof.

3. The system of claim 1, wherein the sub-controllers communicate with the main controller via wireless or carrier wave, and the sub-controllers are electrically connected to the split-phase power adjustment modules, and are used for collecting power and voltage of each phase of the corresponding split-phase power adjustment modules connected to a grid-point, so as to upload them to the main controller, wherein the sub-controllers send control amount calculated by the main controller to the corresponding split-phase power adjustment modules, so as to control the split-phase power adjustment modules to output adjustment power corresponding to the main controller.

4. The system of claim 1, the main controller is used to collect voltage and current of phase A, phase B, and phase C in the transformer area, and calculate three-phase power of the phase A, the phase B, and the phase C to be outputted by the split-phase power adjustment modules according to the voltage and the current of the phase A, the phase B, and the phase C;
wherein power calculation formulas of the phase A, the phase B, and the phase C are as follows:
$${P}_{a} = {u}_{a} * {i}_{a} \\ {P}_{b} = {u}_{b} * {i}_{b} \\ {P}_{c} = {u}_{c} * {i}_{c}$$
where, in the formula, Pa is the power of the phase A in the transformer area, Ua is the voltage of the phase A at a head end in the transformer area, ia is the current of the phase A at the head end in the transformer area, P_{b} is the power of the phase B in the transformer area, U_{b} is the voltage of the phase B at the head end in the transformer area, i_{b} is the current of the phase B at the head end in the transformer area, P_{b} is the power of the phase B in the transformer area, U_{b} is the voltage of the phase B at the head end in the transformer area, and it is the current of the phase B at the head end in the transformer area;
wherein formula for calculating power that the j-th adjustment power supply passing by the node i needs to compensate to the three phases A, B, and C in the transformer area is as follows:
$${\sum }_{j = 1}^{n} \vert {P}_{axj} \vert = \frac{{P}_{a} + {P}_{b} + {P}_{c}}{3} - {P}_{a}$$
$${\sum }_{j = 1}^{n} \vert {P}_{bxj} \vert = \frac{{P}_{a} + {P}_{b} + {P}_{c}}{3} - {P}_{b} \\ {\sum }_{j = 1}^{n} \vert {P}_{cxj} \vert = \frac{{P}_{a} + {P}_{b} + {P}_{c}}{3} - {P}_{c}$$
where, in the formula, n is the number of the adjustment power supplies participating in the adjustment.

5. The system of claim 1, wherein, as the split-phase power adjustment modules ensure the minimum voltage difference among nodes, optimal output values of Pxa, Pxb, Pxc, Qxa, Qxb, and Qxc of the split-phase power adjustment modules are obtained according to a PSO optimization algorithm;
wherein imbalance degree formulas corresponding to the PSO optimization algorithm are:
$$( Pa + Pb + Pc - ( Pxa + pxb + pxc ) ) / 3 = K 1 ; \\ ( \vert Pa - Pxa - K 1 \vert + \vert pb - Pxb - K 1 \vert + \vert Pc - Pxc - K 1 \vert ) / 3 * K 1 = A ;$$
wherein constraints corresponding to the PSO optimization algorithm are:
$$pxa + Pxb + Pxc = Ppv \\ Pxa + pxb + pxc + Qx \leq Svsi \\ A < 5 \%$$
wherein objective formulas corresponding to the PSO optimization algorithm are:
$$M in {\sum }_{j = 1}^{k} Δ {U}_{mj} \\ Δ {U}_{m} = {U}_{m} - {U}_{m - 1} = - \frac{[ {\sum }_{i = m}^{K} ( {P}_{i} - \vert {P}_{xi} \vert ) ] {rl}_{m} + [ {\sum }_{i = m}^{K} ( {Q}_{i} ) ] {xl}_{m}}{{U}_{m - 1}}$$
wherein, in the formula, ΔUₘⱼ is a voltage difference between a node m and a node m-1 after distributed power supplies and energy storage participate in the unbalanced adjustment, k is the total number of the adjustment power supplies connected to the transformer area, Pi is power of each node in the transformer area after the node i, r is resistance corresponding to a line per unit length in the transformer area, x is reactance corresponding to a line per unit length in the transformer area, and lm is length of a line from the head end in the transformer area to the node i.

6. The system of claim 3, wherein, under a condition that the split-phase power adjustment modules ensure that distributed photovoltaic power supplies operate in a maximum power generation mode, unbalanced reference currents I_{a_ref}, I_{b_ref}, I_{c_ref} of output of the split-phase power adjustment modules are determined by formulas as follows:
$${I}_{a \_ ref} = {I}_{a}^{-} + {I}_{a}^{0} + {Ia}^{*} \\ {I}_{b \_ ref} = {I}_{b}^{-} + {I}_{b}^{0} + {Ib}^{*} \\ {I}_{c \_ ref} = {I}_{c}^{-} + {I}_{c}^{0} + {Ic}^{*}$$
wherein, in the formula, Iₐ⁻, I_{b}⁻, I_{c}⁻, Iₐ⁰, I_{b}⁰, I_{c}⁰ represent negative sequence currents and zero sequence currents of required compensating currents obtained through decomposition calculation of unbalanced current sequence components that the split-phase power adjustment modules output, and wherein Ia+, Ib*, and Ic* are control components of the filter capacitor voltage of the split-phase power adjustment modules.

7. The system of claim 6, wherein the control components of the filter capacitor voltage of the split-phase power adjustment modules are Ia*, Ib*, Ic* and are obtained by method as follows:
obtaining a voltage difference between the voltage U_{dc} and U_{dc_ref} at positive and negative terminals of the first filter capacitor and the second filter capacitor connected in series;
outputting a voltage difference after passing by a PI controller as a d-axis active components of dq/abc transformation;
setting q-axis reactive components of the dq/abc transformation to 0;
obtaining capacitance voltage control components Ia*, Ib* and Ic* from the dq/abc transformation.

8. The system of claim 6, wherein unbalanced currents output by the split-phase power adjustment modules are determined by formulas as follows:
$${I}_{aj} = \vert {P}_{axj} \vert / {u}_{aj} \\ {I}_{bj} = \vert {P}_{bxj} \vert / {u}_{bj} \\ {I}_{cj} = \vert {P}_{cxj} \vert / {u}_{cj}$$
wherein, in the formula, uₐⱼ, u_{bj}, u_{cj} are voltages of the three phases A, B, C at a node j, respectively.

9. A split-phase output power adjustment method in a low voltage transformer area, comprising:
S110, detecting a three-phase unbalance degree;
S120, at a condition that the three-phase unbalance degree does not reach a starting value, calculating power to be compensated for each phase in a transformer area;
S130, determining an adjustment power supply that needs to participate in unbalanced adjustment in the transformer area, wherein adjustment power supplies comprise distributed photovoltaic devices and distributed small energy storage power supplies in the transformer area;
S140, calculating unbalanced adjustment power to be output by each split-phase power adjustment module, and determining three-phase compensation reference currents I_{a_ref}, I_{b_ref}, I_{c_ref} of the split-phase power adjustment modules;
S150, obtaining actual compensation currents Iₒₐ, I_{ob}, I_{oc} of converters of phase output modules by tracking the current reference values I_{a_ref}, I_{b_ref}, I_{c_ref} through hysteresis control of converters of the split-phase power adjustment modules;
S160, detecting whether a change range of the three-phase unbalance degree reaches a set offset value;
S170, if the set offset value has not been reached, repeating the steps S120 to S160.

10. A computer-readable storage medium storing a computer program, wherein, when the computer program is executed by a processor, the split-phase output power adjustment method in the low voltage transformer of claim 9 is performed.
